(19) United States
(12) Patent Application Publication
(10) Pub. No.: US 2012/0297936 A1
(43) Pub. Date: Nov. 29, 2012

(54) OPEN END WRENCH

(75) Inventor: KUNG-CHENG CHEN, Shen-Kang Hsiang (TW)

(73) Assignee: E-MAKE Tools Co., Ltd, Shen-Kang Hsiang (TW)

(21) Appl. No.: 13/115,687

(22) Filed: May 25, 2011

(51) Int. Cl. B25B 13/08

(52) U.S. Cl. 81/119

(57) ABSTRACT

An open end wrench includes a handle; and a spaced pair of jaws secured to and projecting from the handle, one of the jaws comprising a first engagement surface and a second engagement surface together arranged in an angled pair, and the other of the jaws comprising a third engagement surface, a fourth engagement surface spaced from the third engagement surface, and a concave surface between the third engagement surface and the fourth engagement surface, the third engagement surface being not parallel to the fourth engagement surface. The second engagement surface extends at an angle between 2-degree and 7-degree with respect to a virtual center line passing an opening between the pair of jaws. The fourth engagement surface extends at an angle between 2-degree and 5-degree with respect to the virtual center line. The second engagement surface is not parallel to the fourth engagement surface.

### BACKGROUND OF THE INVENTION

1. Field of the Invention

The invention relates to open end wrench and more particularly to an open end wrench with improved characteristics.

2. Description of Related Art

A wrench is a tool used to provide grip and mechanical advantage in applying torque to turn objects (e.g., bolt heads or nuts) or keep them from turning and well known in the art. Varieties of wrenches include two headed open end wrenches typically formed from a single piece of steel.

Open end wrenches have the advantage of lacking relatively movable parts. However, conventional open end wrenches are deficient. In detail, many fasteners require a large number of rotations of their threaded shanks to fully install and remove, and an open end wrench is frequently removed from engagement with the fastener head and replaced thereon in an advantageous position to turn the fastener. The effort of frequently removing and replacing an open end wrench is laborious in that it greatly increases the amount of time to install and remove fasteners.

There is a conventional open end wrench having a head with three projections at one jaw and a convex portion at the other opposite jaw. Each projection ahs a first engagement surface and a second engagement surface arranged in an angled pair. A hexagonal nut has one of six faces engaged with the convex portion in a point-to-point contact, a second opposite face engaged with the first engagement surface in a point-to-point contact, and a third surface adjacent the second face engaged with a substantial portion of the second engagement surface prior to applying torque. However, the engagements are not tight. Thus in often times the wrench head may slip out of engagement with the nut when applying torque. Thus, the need for improvement still exists.

### SUMMARY OF THE INVENTION

It is therefore one object of the invention to provide an open end wrench comprising a handle; and a spaced pair of jaws secured to and projecting from the handle, one of the jaws comprising a first engagement surface and a second engagement surface together arranged in an angled pair, and the other of the jaws comprising a third engagement surface, a fourth engagement surface spaced from the third engagement surface, and a concave surface between the third engagement surface and the fourth engagement surface, the third engagement surface being not parallel to the fourth engagement surface; wherein the second engagement surface extends at an angle between 2-degree and 7-degree with respect to a virtual center line passing an opening between the pair of jaws; wherein the fourth engagement surface extends at an angle between 2-degree and 5-degree with respect to the virtual center line; and wherein the second engagement surface is not parallel to the fourth engagement surface.

The above and other objects, features and advantages of the invention will become apparent from the following detailed description taken with the accompanying drawings.

### BRIEF DESCRIPTION OF THE DRAWINGS

FIG. 1 is a perspective view of a head and an adjacent portion of a handle of an open end wrench according to a first preferred embodiment of the invention;

FIG. 2 is a plan view of the wrench of FIG. 1 fitted over a bolt prior to applying torque to the bolt;

FIG. 3 is a view similar to FIG. 2 showing the wrench head fitted over a bolt;

FIG. 4 is a detailed view of the area in circle 4 of FIG. 3;

FIG. 5 is a view similar to FIG. 3 showing a clockwise turning of the wrench head for applying torque to the bolt;

FIG. 6 is a detailed view of the area in circle 6 of FIG. 5;

FIG. 7 a perspective view of combination wrench according to a second preferred embodiment of the invention with one open end fitted over a bolt prior to applying torque to the bolt; and

FIG. 8 is a plan view of another configuration of the open end wrench according to the first preferred embodiment of the invention.

### DETAILED DESCRIPTION OF THE INVENTION

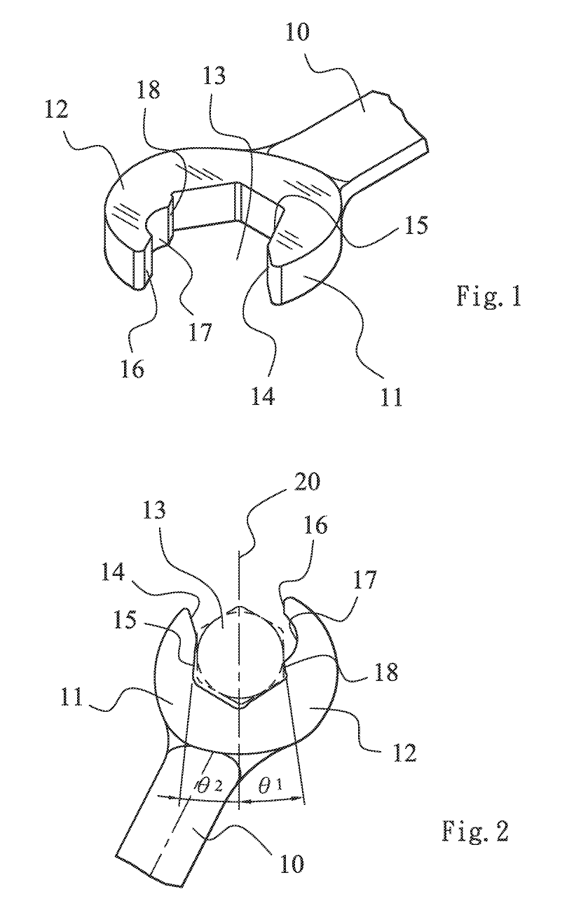

Referring to FIGS. 1 to 6, an open end wrench in accordance with the invention comprises the following components as discussed in detail below.

A handle 10 is provided and a spaced pair of jaws (e.g., a first jaw 11 and a second jaw 12) is secured to one end of the handle 10 and projecting from the handle 10. An opening 13 is formed between the first and second jaws 11, 12. A virtual center line 20 passes through the opening 13 for purposes as detailed later. The first jaw 11 comprises a straight, flat first engagement surface 14 at the mouth of the opening 13, and a straight, flat second engagement surface 15 adjacent to a V-shaped bottom of the opening 13, the first and second engagement surfaces 14, 15 being arranged in an angled pair both facing the virtual center line 20. The second jaw 12 comprises a convex third engagement surface 16 at the mouth of the opening 13, a straight, flat fourth engagement surface 18 adjacent to the V-shaped bottom of the opening 13, and a concave surface 17 between the third engagement surface 16 and the fourth engagement surface 18.

The second engagement surface 15 extends at an angle θ2 with respect to the virtual center line 20. Preferably, angle θ2 is between 2-degree and 7-degree. The fourth engagement surface 18 extends at an angle θ1 with respect to the virtual center line 20. Preferably, angle θ1 is between 2-degree and 5-degree. The second engagement surface 15 is not parallel to the fourth engagement surface 18. Length of the third engagement surface 16 is less than that of each of the first engagement surface 14 and the second engagement surface 15. The third engagement surface 16 is curved outward so as to increase the mouth of the opening 13. This in turn facilitates the wrench head to fit over an object (e.g., bolt 30). Preferably, a contact area of the bolt 30 and the fourth engagement surface 18 is between 1-35% of a total area of the fourth engagement surface 18. Length of the fourth engagement surface 18 is less than that of the second engagement surface 15. The fourth engagement surface 18 extends at an angle θ4 with respect to one proximate surface of the V-shaped bottom of the opening 13. Preferably, angle θ4 is equal to or greater than 120-degree. One surface of the V-shaped bottom of the opening 13 extends at an angle θ3 (equal to or greater than 0-degree) with respect to one face of the bolt 30 fitted in the opening 13 when the handle 10 rotates clockwise an angle. Preferably, angle θ3 is equal to or greater than angle θ1. Note that the bolt 30 can be replaced with a nut without departing from the scope of the invention.

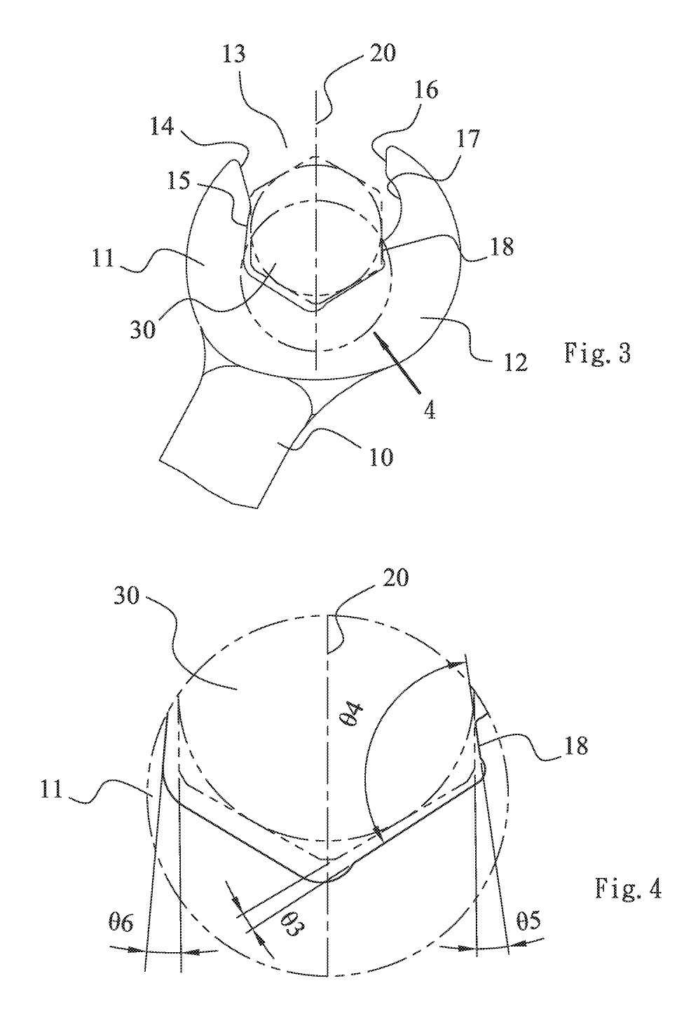

As shown in FIGS. 3 and 4, a user may first fit the opening 13 over the head of the bolt 30. Contact area of the bolt 30 with the second engagement surface 15 is not equal to that of the bolt 30 with the fourth engagement surface 18 because the second engagement surface 15 is not parallel to the fourth engagement surface 18 as discussed above. The fourth engagement surface 18 extends at an angle 05 with respect to the engaged face of the head of the bolt 30 and the second engagement surface 15 extends at an angle θ6 with respect to the opposite engaged face of the head of the bolt 30. Angle θ5 is equal to angle θ1 and angle θ6 is equal to angle θ2.

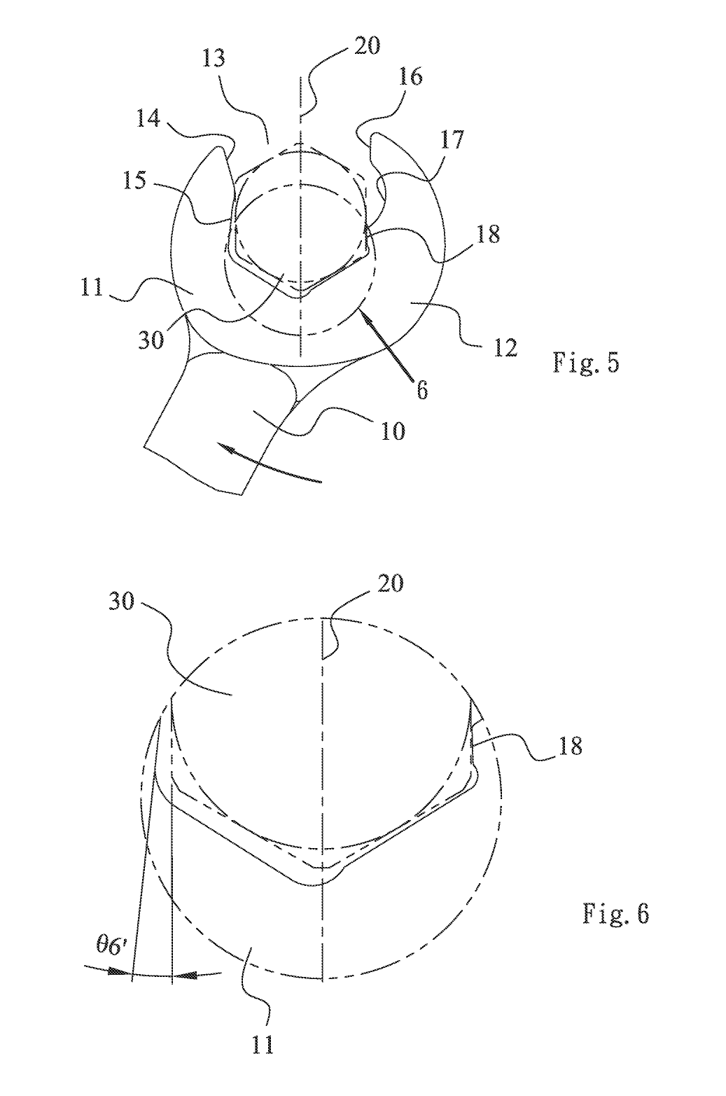

As shown in FIGS. 5 and 6, the user may then tighten the bolt 30 by clockwise turning the wrench head in a manner well known in the art. The fourth engagement surface 18 may fully engage with the bolt 30 after turning the angle θ5 (i.e., from a point contact (see FIG. 4) to a surface contact (see FIG. 6)). The angle θ6 is increased to angle θ6′ which is equal to the sum of angle θ5 and angle θ6.

Advantageously, the user substantially may not need to remove the wrench head from engagement with the bolt 30 prior to turning the bolt 30 again due to the cooperation of the first engagement surface 14, the second engagement surface 15 and the fourth engagement surface 18. Moreover, the projection at the joining portion of the first engagement surface 14 and the second engagement surface 15, and that at the joining portion of the concave surface 17 and the fourth engagement surface 18 together can tightly grip the bolt 30 and provide mechanical advantage in applying torque to turn the bolt 30. This has the benefits of causing no slip, labor saving and increasing efficacy.

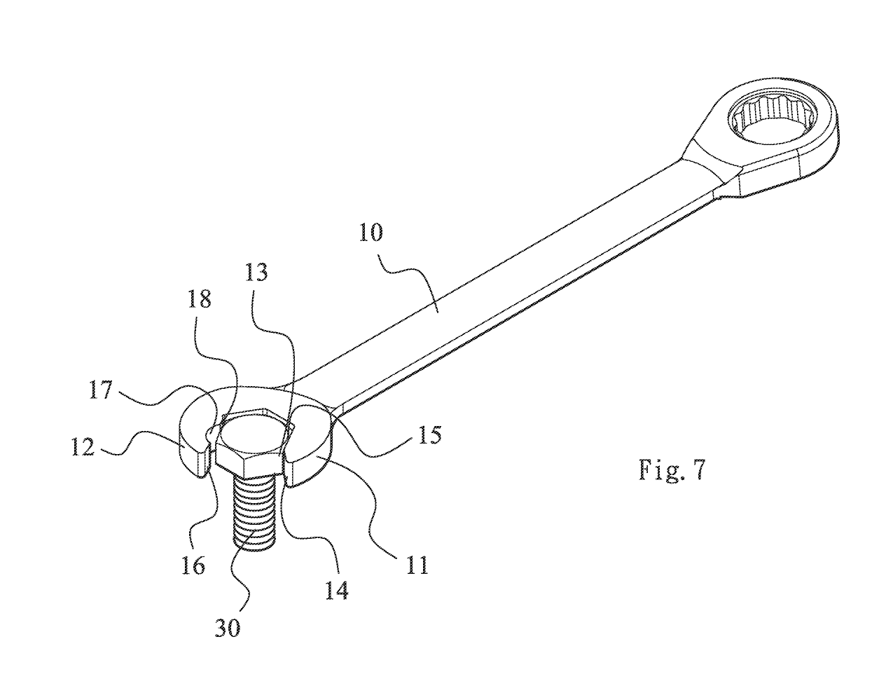

Referring to FIG. 7, a combination wrench in accordance with a second preferred embodiment of the invention is shown. One end of the combination wrench is the same as one end of the open-end wrench described above and the other end thereof is like a box-end wrench.

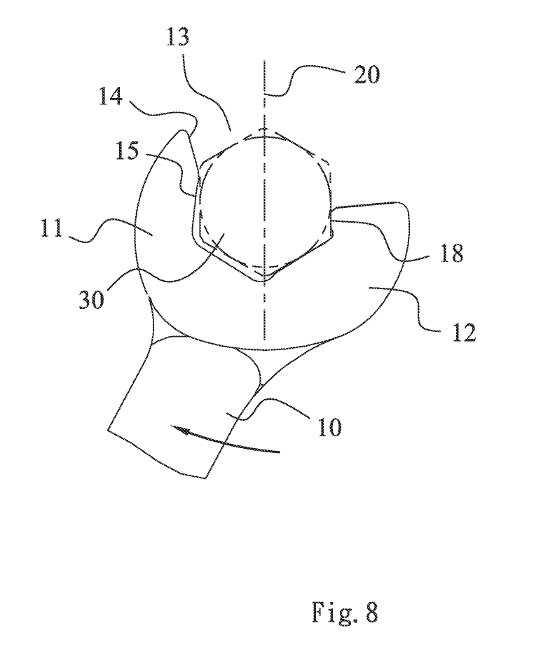

Referring to FIG. 8, another configuration of the open end wrench in accordance with the first preferred embodiment of the invention is shown. It is characterized in that both the third engagement surface 16 and the concave surface 17 are eliminated without sacrificing the advantageous effects of the invention described above.

While the invention has been described in terms of preferred embodiments, those skilled in the art will recognize that the invention can be practiced with modifications within the spirit and scope of the appended claims.

1. An open end wrench for torquing polygonal fastener heads and nuts, comprising:
a handle; and
a spaced pair of jaws secured to and projecting from the handle, one of the jaws comprising a first engagement surface and a second engagement surface together arranged in an angled pair, and the other of the jaws comprising a third engagement surface, a fourth engagement surface spaced from the third engagement surface, and a concave surface between the third engagement surface and the fourth engagement surface, the third engagement surface being not parallel to the fourth engagement surface;
wherein the second engagement surface is closer to a bottom of one of the laws than the first engagement surface;
wherein the fourth engagement surface is closer to a bottom of the other of the laws than the third engagement surface;
wherein the second engagement surface extends at an angle between 2-degree and 7-degree with respect to a virtual center line passing an opening between the spaced pair of jaws;
wherein the fourth engagement surface extends at an angle between 2-degree and 5-degree with respect to the virtual center line; ad
wherein the second engagement surface is not parallel to the fourth engagement surface; and
wherein a first recess is set between one of the jaws and the second engagement surface, a second recess is set between one of the jaws and the other of the jaws, and a third recess is set between the other of the jaws and the fourth engagement surface for preventing from damage of the polygonal fastener heads or nuts.

2. (canceled)

3. The open end wrench of claim 1, wherein length of the fourth engagement surface is less than that of the second engagement surface.

4. The open end wrench of claim 1, wherein the fourth engagement surface extends at an angle greater than 120-degree with respect to one proximate surface of a bottom of the opening.

5. The open end wrench of claim 1, wherein one surface of a bottom of the opening extends at an angle equal to or greater than 0-degree with respect to one face of the fastener head or the nut fitted in the opening when the handle rotates clockwise an angle.

6. An open end wrench for torquing polygonal fastener heads and nuts, comprising:
a handle; and
a spaced pair of jaws secured to and projecting from the handle, one of the jaws comprising a first engagement surface and a second engagement surface together arranged in an angled pair, and the other of the jaws comprising a fourth engagement surface;
wherein the second engagement surface is closer to a bottom of one of the jaws than the first engagement surface;
wherein the second engagement surface extends at an angle between 2-degree and 7-degree with respect to a virtual center line passing an opening between the spaced pair of jaws;
wherein the fourth engagement surface extends at an angle between 2-degree and 5-degree with respect to the virtual center line;
wherein the second engagement surface is not parallel to the fourth engagement surface; and
wherein a first recess is set between one of the jaws and the second engagement surface, a second recess is set between one of the jaws and the other of the jaws, and a third recess is set between the other of the jaws and the fourth engagement surface for preventing from damage of the polygonal fastener heads or nuts.

7. (canceled)

8. The open end wrench of claim 6, wherein length of the fourth engagement surface is less than that of the second engagement surface.

9. The open end wrench of claim 6, wherein the fourth engagement surface extends at an angle greater than 120-degree with respect to one proximate surface of a bottom of the opening.

10. The open end wrench of claim 6, wherein one surface of a bottom of the opening extends at an angle equal to or greater than 0-degree with respect to one face of the fastener head or the nut fitted in the opening when the handle rotates clockwise an angle.
